(19) United States
(12) Patent Application Publication
(10) Pub. No.: US 2017/0097765 A1
(43) Pub. Date: Apr. 6, 2017

(54) Method to Provide a Service While Inputting Content in an Application Though A Virtual Keyboard

(71) Applicant: IQ TECHNOLOGY INC., New Taipei City (TW)

(72) Inventor: Hsu-Kuang Chao, New Taipei City (TW)

(21) Appl. No.: 15/285,481

(22) Filed: Oct. 5, 2016

Related U.S. Application Data
(60) Provisional application No. 62/237,534, filed on Oct. 5, 2015.

(51) Int. Cl. G06F 3/0488; G06F 3/0482; G06F 3/023; H04W 4/02

(52) U.S. Cl. CPC G06F 3/04886; H04W 4/02; G06F 3/0482; G06F 3/04883; G06F 3/0237; G06F 3/0236

(57) ABSTRACT

A method of providing a service while inputting content in an application through a virtual keyboard program is disclosed, the method comprising: tapping an input field of a first application to lunch a virtual keyboard program for inputting content, wherein at least one predicted content is displayed in a prediction list area, wherein at least one service is displayed by pressing a finger on a predicted content and sliding in a direction away from the prediction list area, wherein a service is selected by continuous sliding of the finger onto an identification of the service and lifting the finger from that identification, so as to compose and execute code according to the selected service to run a second application for obtaining new contents for inputting content to the first application.

### CROSS-REFERENCES TO RELATED APPLICATIONS

This application claims the benefit of U.S. Provisional Patent Application No. 62237534 filed on Oct. 5, 2015, which is hereby incorporated by reference herein and made a part of specification.

### BACKGROUND OF THE INVENTION

1. Field of the Invention

The invention relates in general to a method for inputting content using an input field of an application through a virtual keyboard and, in particular, to a method for providing a service while inputting content into an application.

2. Description of the Prior Art

A virtual keyboard is an on-screen keyboard that helps user to input contents. For instant messaging applications, such as Twitter, Facebook Messenger, Line or WeChat, a virtual keyboard program is used for chatting with friends. In a smart phone or an electronic device having a touch screen for displaying and inputting, the pre-configured virtual keyboard (also known as the software keyboard or IME—Input Method Editor) is brought up and displayed on the touch screen by clicking on the input field of the application, in which the user can then input messages. In conventional technologies, obtaining for relevant information when chatting with friends involves temporarily exiting the instant messaging application and starting another application, such as Google, from which the user will then have to copy and paste a portion of interest of the browsed information back to the original messaging application in order to continue chatting with friends, which is a very complex and inconvenient process.

Therefore, what is needed is a fast and efficient way to obtain information that is useful for chatting with friends during inputting content into an application.

### SUMMARY OF THE INVENTION

The present invention uses features of a virtual keyboard program to help a user enter contents during instant messaging without leaving the current application, by using characteristics of the virtual keyboard, comprising pressing and holding a predicted content, and then sliding up, down or other in any other suitable directions, to allow the system to automatically bring out a service list so as to select a service for executing a second application corresponding to the selected service without leaving the current application.

In one embodiment, a method to provide a service while inputting content in an application through a virtual keyboard program is disclosed, the method comprising: running a virtual keyboard program launched by a first application with an input field for inputting content on a touch screen of an electronic device; displaying at least one predicted content in a prediction list area in response to an inputting action on a virtual keyboard that is displayed on the touch screen by said virtual keyboard program; detecting a pressing of a finger on a predicted content in said prediction list area to select said content and a continuous sliding of the finger in a direction away from the prediction list area on the touch screen; displaying at least one identification of services in a service list area on the touch screen; continuous sliding the finger onto an identification in the service list area on the touch screen and lifting the finger from said identification to select the service represented by said identification; and composing and executing code according to the selected service to run a second application for obtaining new contents for inputting content to said first application, said code comprising a first portion for identifying the second application and a second portion comprising information associated with said selected content for identifying said new contents.

In one embodiment, composing and executing code further comprising sending said selected content to the input field of the first application.

In one embodiment, composing and executing code further comprising obtaining a new content from the second application and sending said new content to the first application though said virtual keyboard program.

In one embodiment, composing and executing code further comprising: obtaining a new content from the second application; and sending said selected content and the new content to the first application though said virtual keyboard program by a command.

In one embodiment, wherein said predicted contents in prediction list area comprises at least one of the following: a word, a phrase, a text string, a symbol, an emoticon and a picture.

In one embodiment, said continuous sliding of the finger in a direction away from the prediction list area is sliding down to the area below the prediction list area.

In one embodiment, said continuous sliding of the finger in a direction away from the prediction list area is sliding up to the area above the prediction list area.

In one embodiment, wherein said service list area fully occupies the original virtual keyboard area.

In one embodiment, wherein said service list area overlays on a portion of the original virtual keyboard area.

In one embodiment, wherein said service list area is located above the prediction list area.

In one embodiment, wherein said service list area occupies the whole touch screen of the electronic device.

In one embodiment, wherein each identification of a service comprises the name of the service.

In one embodiment, wherein each identification of a service comprises an icon of the service.

In one embodiment, wherein the at least one identification of services in said service list area is chosen according to the selected content.

In one embodiment, wherein the at least one identification of services in said service list area is further chosen according to the location of the electronic device.

In one embodiment, wherein the at least one identification of services in said service list area is further chosen according to the type of the first application.

In one embodiment, wherein the at least one identification of services in said service list area is further chosen according to information corresponding to the selected content in a database or type of the selected content.

In one embodiment, wherein the at least one identification of services in said service list area is further chosen according to at least one of the followings: type of the electronic device, the language being used on the virtual keyboard, gender of the user, age of the user, preference of the user, and present time.

In one embodiment, wherein said second application is an external web browser or an external application program linked to the virtual keyboard program through the operating system of the electronic device.

In one embodiment, wherein said second application is an internal program embedded inside the virtual keyboard program to browse web pages or a list of contents.

In one embodiment, wherein said a new content is obtained from a list of contents displayed by said second application.

In one embodiment, wherein said a new content is an URL of a web page obtained from said second application.

In one embodiment, wherein said a new content is a screenshot picture obtained from said second application.

In one embodiment, wherein said information associated with said selected content includes at least one of the followings: the selected content itself, the related word of the selected content, and information corresponding to the selected content in a database for identifying said new contents.

In one embodiment, wherein said second portion further comprises information associated with the location of the electronic device for identifying said new contents.

Other objects, technical contents, features and advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:
FIG. 1 illustrates a flow chart of a method to provide a service while inputting content in an application through a virtual keyboard program in accordance with one embodiment of present invention.
FIG. 2 illustrates a virtual keyboard program launched by a first application with an input field for inputting content on a touch screen of a mobile phone;
FIGS. 2A-2D illustrate examples of at least one predicted content with various prediction results in a prediction list area in response to an inputting action on a virtual keyboard;
FIGS. 3A-3D and 3E-3F illustrate different examples of a finger on a predicted content in the prediction list area to select the content and a continuous sliding of the finger in a direction away from the prediction list area on the touch screen; and at least one identification of services is displayed in a service list area on the touch screen;
FIGS. 4A-4D illustrate examples of running a second application to browse web pages or a list of contents for obtaining new contents.
FIGS. 5A-5C and 5D-5E illustrate further examples of a finger on a predicted content in the prediction list area to select the content and a continuous sliding of the finger in a direction away from the prediction list area on the touch screen; and at least one identification of services is displayed in a service list area on the touch screen;
FIGS. 6A-6D illustrate further examples of running a second application for obtaining new contents for inputting content to the first application.
FIGS. 7A-7D illustrate the result of sending a new content to the first application, and the new content is obtained from the second application.

### DETAILED DESCRIPTION OF THE INVENTION

The detailed explanation of the present invention is described as following. The described preferred embodiments are presented for purposes of illustrations and description, and they are not intended to limit the scope of the present invention.

Present invention discloses a method for providing a service while inputting content in an application using a virtual keyboard program.

The method is provided for helping users to use a service while inputting content in an input field of an application so as to obtain useful information from other sources such as web pages for chatting without leaving the current application program through the features of the virtual keyboard, which is popular for inputting content on a portable electronic device having a touch screen, such as a mobile phone.

FIG. 1 shows a flow chart of a method to provide a service while inputting content in an application through a virtual keyboard program in accordance with one embodiment of present invention.

As shown in FIG. 1:
In step 111, running a virtual keyboard program launched by a first application with an input field for inputting content on a touch screen of an electronic device;
In step 112, displaying at least one predicted content in a prediction list area in response to an inputting action on a virtual keyboard that is displayed on the touch screen by said virtual keyboard program;
In step 113, detecting a pressing of a finger on a predicted content in said prediction list area to select said content and a continuous sliding of the finger in a direction away from the prediction list area on the touch screen;
In step 114, displaying at least one identification of services in a service list area on the touch screen;
In step 115, continuous sliding the finger onto an identification in the service list area on the touch screen and lifting the finger from said identification to select the service represented by said identification; and
In step 116, composing and executing code according to the selected service to run a second application for obtaining new contents for inputting content to the first application, said code comprising a first portion for identifying the second application and a second portion comprising information associated with said selected content for identifying said new contents.

FIG. 2 shows a picture for inputting content on a touch screen of a mobile phone, wherein an input field 100 of an application 900 (such as Twitter, Line, Facebook, messenger, etc.) is used for inputting content to the application through a virtual keyboard program 300, a prediction list area 101 displays a list of predicted contents 102 for a user to select and a virtual keyboard area 103 is used for inputting content into the input field, wherein each predicted content can be a word, a phrase, a text string, a symbol, an emoticon, or a picture, etc.

While a user is inputting content into the input field of the application, the predicted contents in the prediction list area can be displayed in many different forms, and the present invention is not limited to the prediction forms. Four examples of the prediction forms are described below for illustration purpose.

As shown in FIG. 2A, the prediction pattern is an English word prediction. The predicted contents for inputted letters “seaf” 100a are “seaf”, “swag”, and “seafood” 101a.

As shown in FIG. 2B, the prediction pattern is an English next word prediction. The predicted contents for inputted letters “seafood” 100b are “and”, “restaurant”, and “the” 101b.

As shown in FIG. 2C, the prediction pattern is an English word prediction, wherein “seafood” 100c is in front of the cursor, and the predicted contents for inputted letters “seafood” 100c thereof are “seafood” and “seafoods” 101c.

As shown in FIG. 2D, the prediction pattern is a Traditional Chinese word prediction, wherein the inputting symbols are “ [symbol] ” 100d (Chinese phonetic symbols), and the predicted contents for “ [symbol] ” 100d thereof are “ [symbol] ” (corresponding to beef noodles in Chinese), “ [symbol] ” (corresponding to “men” in Chinese), and “ [symbol] [symbol] ” (corresponding to “women” in Chinese) 101d.

In one embodiment, as shown in FIG. 3A, a predicted content “seafood” 104 in the prediction list area 101 on a virtual keyboard program 300, is pressed by a finger 105 to select the content “seafood” 104, and the finger 105 will continue to slide down to the virtual keyboard area 103, at this time, at least one identification of services represented by service names or icons, such as “Yelp” 250 service, will be popped up and displayed in a service list area 200 for a user to select, as shown in FIG. 3B. The candidate services can include but not limited to the following services: Yelp 250, Contacts, Translate, Google, Shopping, Movie, Calendar, and TripAdvisor. If the finger 105 continues to slide and move onto a service “Yelp” 250 in the service list area 200 and lifts from the touch screen as shown in FIG. 3C, the corresponding code will be composed and executed according to the selected service “Yelp” 250 to run a second application for obtaining new contents for inputting content to said input field of the first application, said code comprising a first portion for identifying the second application and a second portion comprising information associated with said selected content for identifying said new contents.

An example of said code “https://m.yelp.ca/search?find_desc=seafood” 401 is composed and executed to start an external web browser program 400 for “Yelp” web page through the operating system as shown in FIG. 4A, wherein the code is composed of a first portion “https://m.yelp.ca/search?” predefined with the selected service “Yelp” 250 for running the second application and a second portion “find_desc=seafood” which is the information associated with the selected content “seafood” 104, wherein the external web browser program 400 will launch “Yelp” web page “https://m.yelp.ca/” and take “seafood” 402 as the search input for obtaining new contents.

Another example of said code “https://m.yelp.ca/search?find_desc=seafood” is composed and executed to start an external “Yelp” App program 410 through the operating system, as shown in FIG. 4B, wherein the code is composed of a first portion “https://m.yelp.ca/search?” predefined with the selected service “Yelp” 250 for running the second application and a second portion “find_desc=seafood” which is the information associated with the selected content “seafood” 104, wherein the “Yelp” App program 410 will take “seafood” 402 as the search input for obtaining new contents.

In one embodiment, the second portion of said code further includes the location of the electronic device “Irvine” as: “https://m.yelp.ca/search?find_desc=seafood&find_loc=Irvine” 403, wherein the code will be executed to start an external web browser program for “Yelp” web page as shown in FIG. 4C, wherein the external web browser program 400 will launch “Yelp” web page “https://m.yelp.ca/” and take both “seafood” 402 and “Irvine” 404 as the search inputs for obtaining new contents; Another example as shown in FIG. 4D, the code will be executed to start an external “Yelp” App program 410 and take both “seafood” 402 and “Irvine” 404 as the search inputs for obtaining new contents.

In one embodiment, the second portion of said code includes related words of the selected content or information corresponding to the selected content in a database. For examples, “Sashimi” is a related word of selected content “seafood”, the code could be “https://m.yelp.ca/search?find_desc=sashimi” instead of https://m.yelp.ca/search?find_desc=seafood, “Indian Restaurant” is the information corresponding to the selected “spice” in a database, the code could be “https://m.yelp.ca/search?find_desc=Indian+Restaurant” instead of https://m.yelp.ca/search?find_desc=spice”.

Please note that the services in the service list area 200 are called the candidate services. Each candidate service such as “Yelp” 250 service, as shown in FIG. 3C, is represented as a name or an icon that can be called as the identification of the candidate service.

The candidate services can vary according to the selected content or other different factors. For example, if the selected content is “seafood”, the candidate services could be seafood related services such as “Yelp” service; if the location of the electronic device is in China, the candidate services could be the services in China such as “Dianping” service, which is a very famous restaurant recommendation service in China; if the type of the first application is shopping application, the candidate services could be other shopping applications or services; if the information corresponding to the selected content “seafood” in a database is “food allergy”, the candidate services could be food allergy related services; if the type of the selected content “Shellfish” is “seafood”, the candidate services could be seafood related services;

The candidate services can further be chosen according to one of the following factors: the type of the electronic device (i.e., iPad or iPhone); the language being used on the virtual keyboard (i.e., English or Chinese); the gender of the user (i.e., female or male); the age of the user (i.e., teenager or elderly people); the preference of the user (i.e., the preferences defined by user itself); the present time (i.e., traffic hours, working hours, etc.), or in any combination of them.

In one embodiment, in order to generate a service list by pressing a predicted content, the finger can also slide in a direction away from the prediction list area, such as sliding up, sliding to the left or sliding to the right or sliding in other suitable directions, to generate a service list displayed in a service list area, wherein the service list area can be located above or below the prediction list area, such as overlays on a portion of the original virtual keyboard area, fully occupies the original virtual keyboard area, occupies some other location on the touch screen, or even occupies the whole touch screen, wherein the identifications of the candidate services will be displayed in the service list area.

As shown in FIG. 5A, the finger 105 is pressing on the selected content such as “seafood” 104 and continuing to slide up, and then a service list area 200 will be displayed above the prediction list area 101 to show at least one identification of services, such as “TripAdvisor” 260 service as shown in FIG. 5B.

If the finger 105 is pressing “seafood” and sliding to “TripAdvisor” 260 and then lifts from the touch screen, the code “http ://www.trip advisor.com/Search?q=seafood&geo=32530&pid=3825” will be composed and executed to start an second application for browsing web pages or a list of contents, wherein the code is composed of a first portion “http://www.tripadvisor.com/Search?” predefined with the selected service “TripAdvisor” 260 for running the second application and a second portion “q=seafood” which is the information associated with the selected content “seafood” 104, and “geo=32530&pid=3825” which is the location information of the of the electronic device.

An example of above second application is an internal program “Keyboard WebView” 500 embedded inside the virtual keyboard program is popped up for browsing web pages or a list of contents for obtaining new contents, as shown in FIG. 6A.

Another example of above second application is an internal program 510 embedded inside virtual keyboard is displayed for browsing a list of contents 504 for obtaining new contents, as shown in FIG. 6D.

In one embodiment, the user can issue a command to send an obtained new content from the second application to the first application, or send both the selected content and the obtained new content from the second application to the first application through the virtual keyboard program.

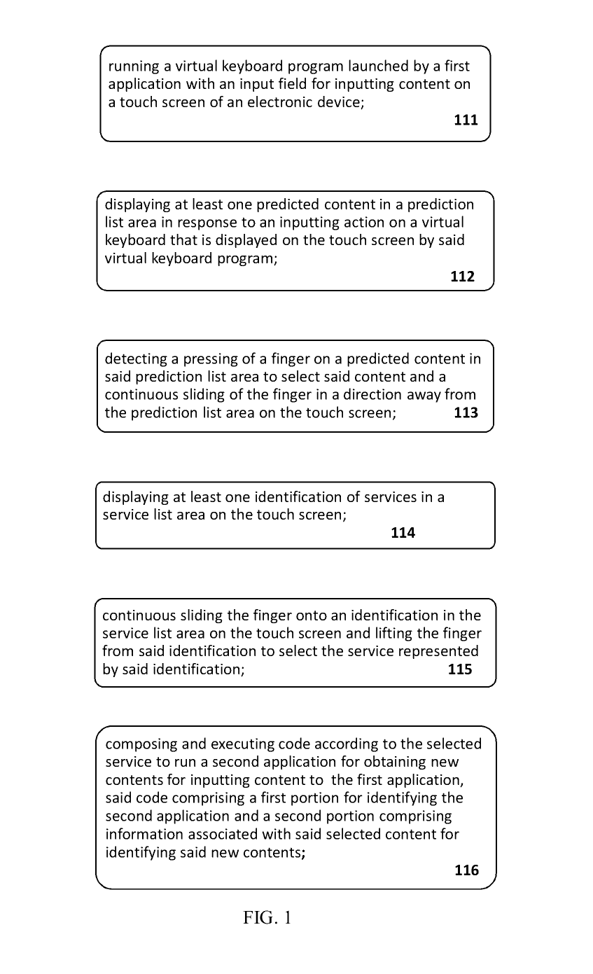

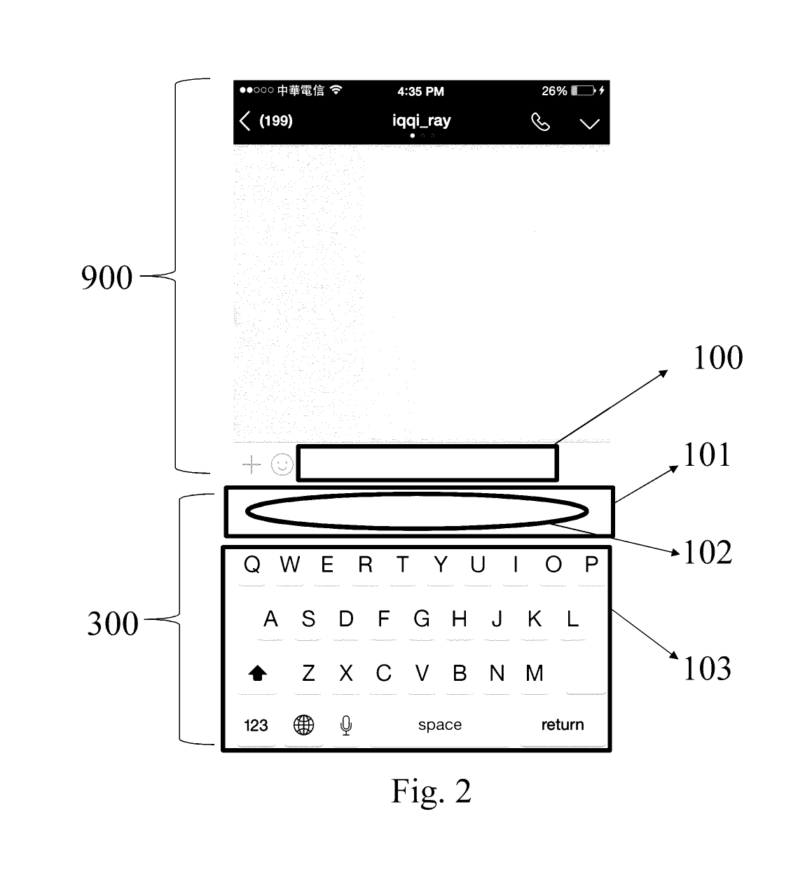

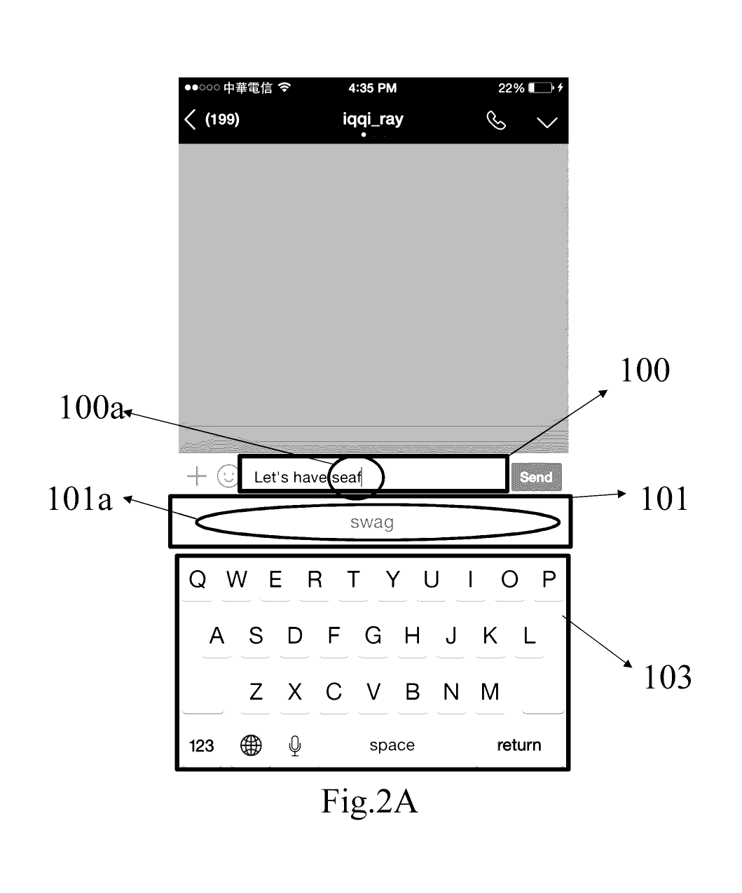

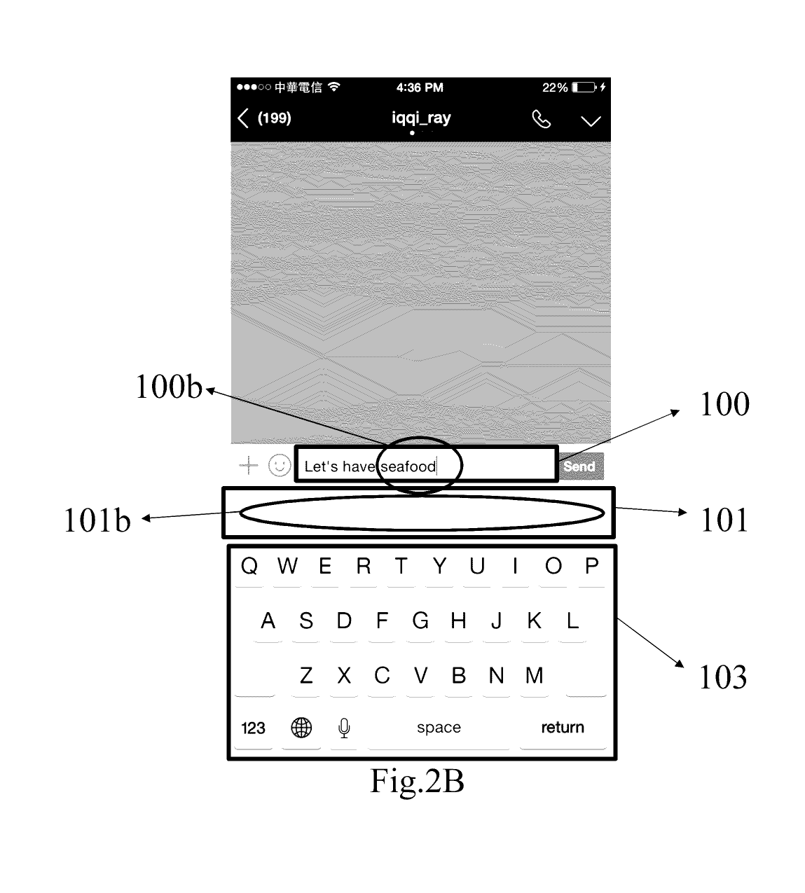

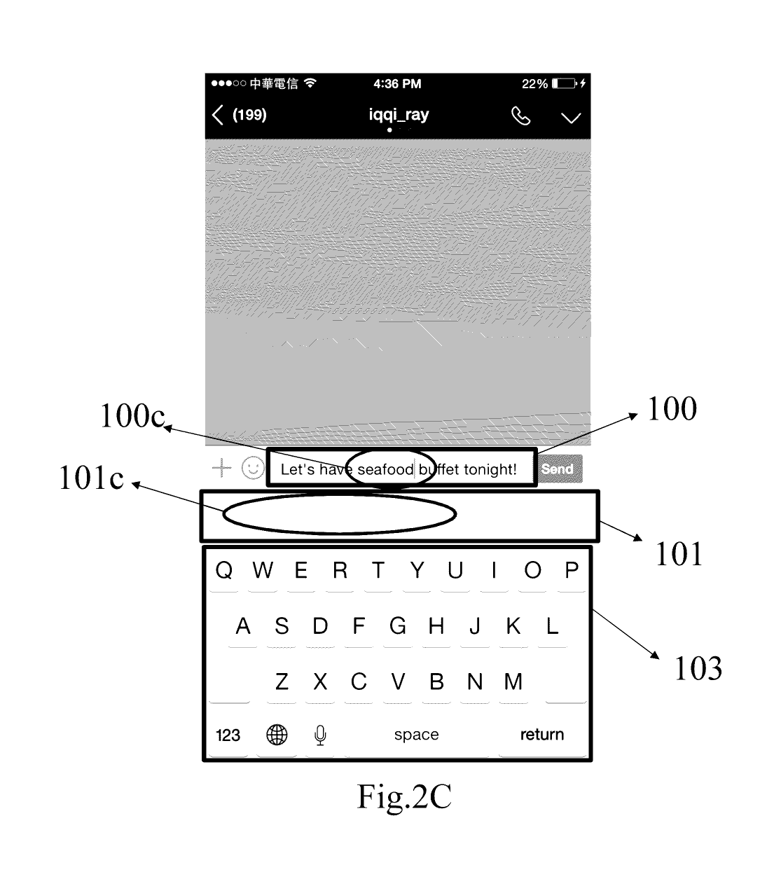

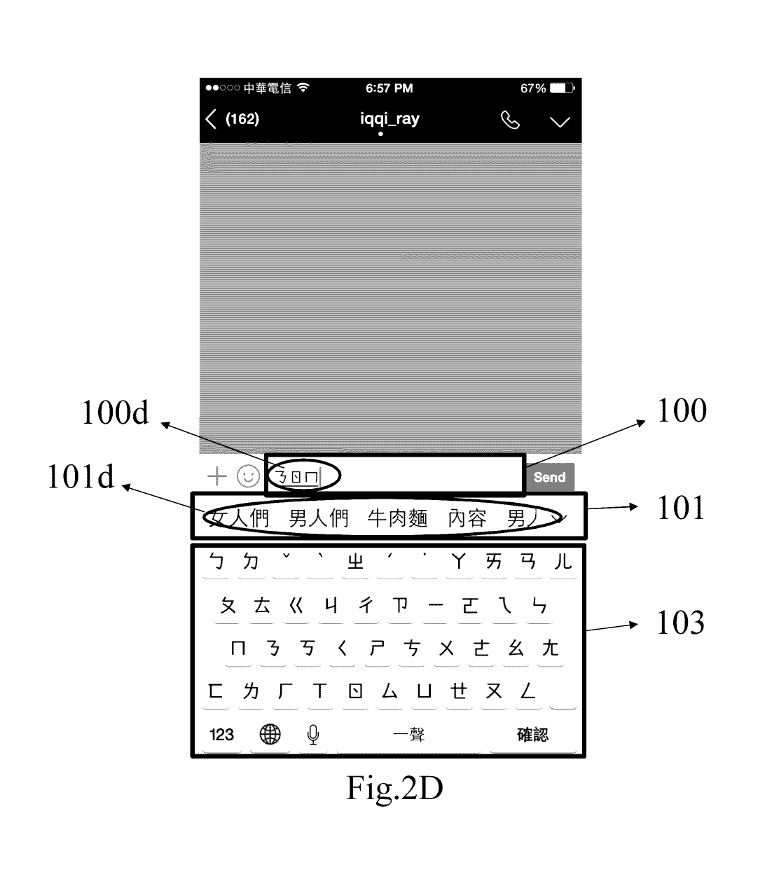

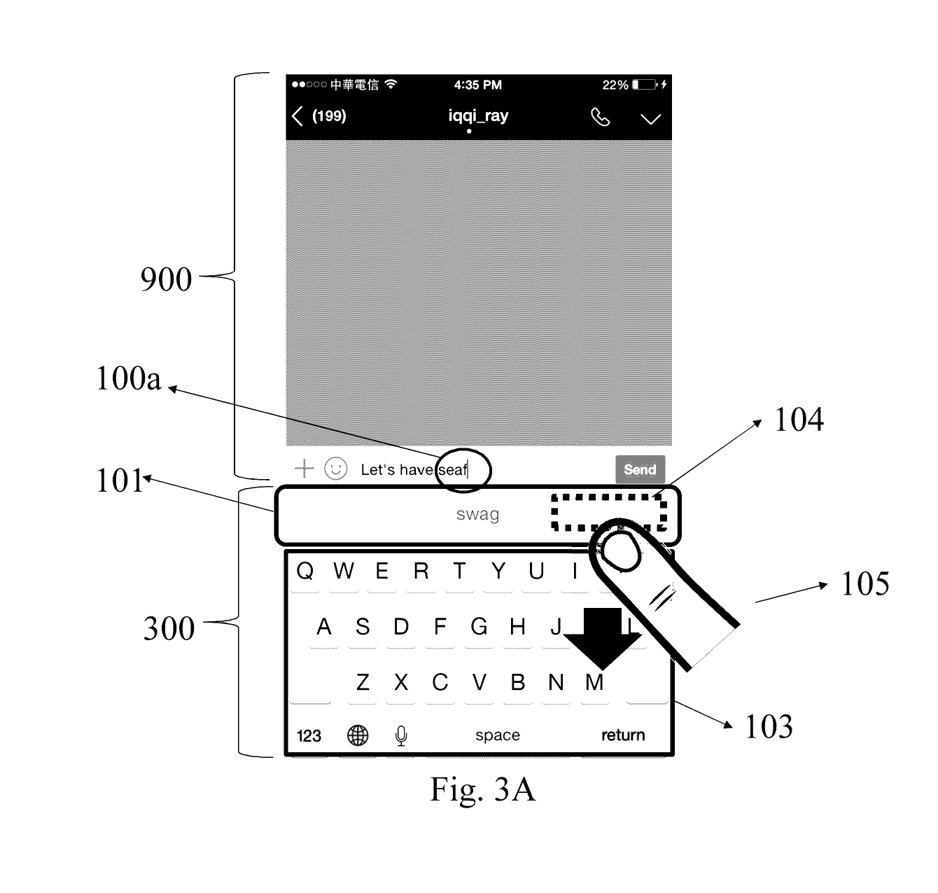

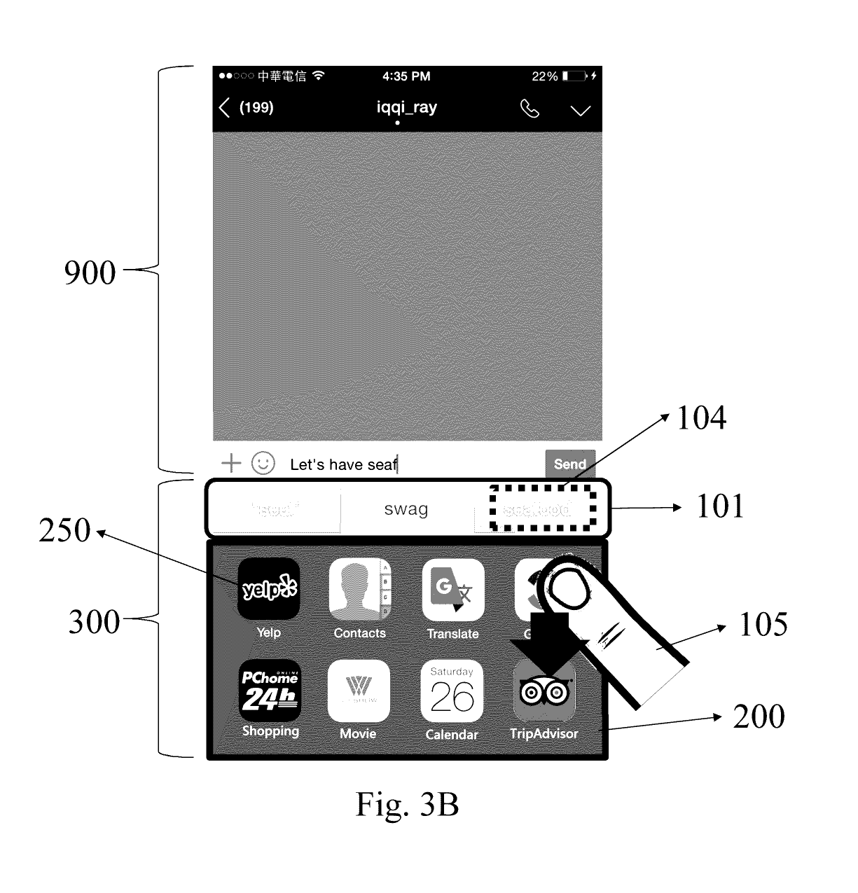

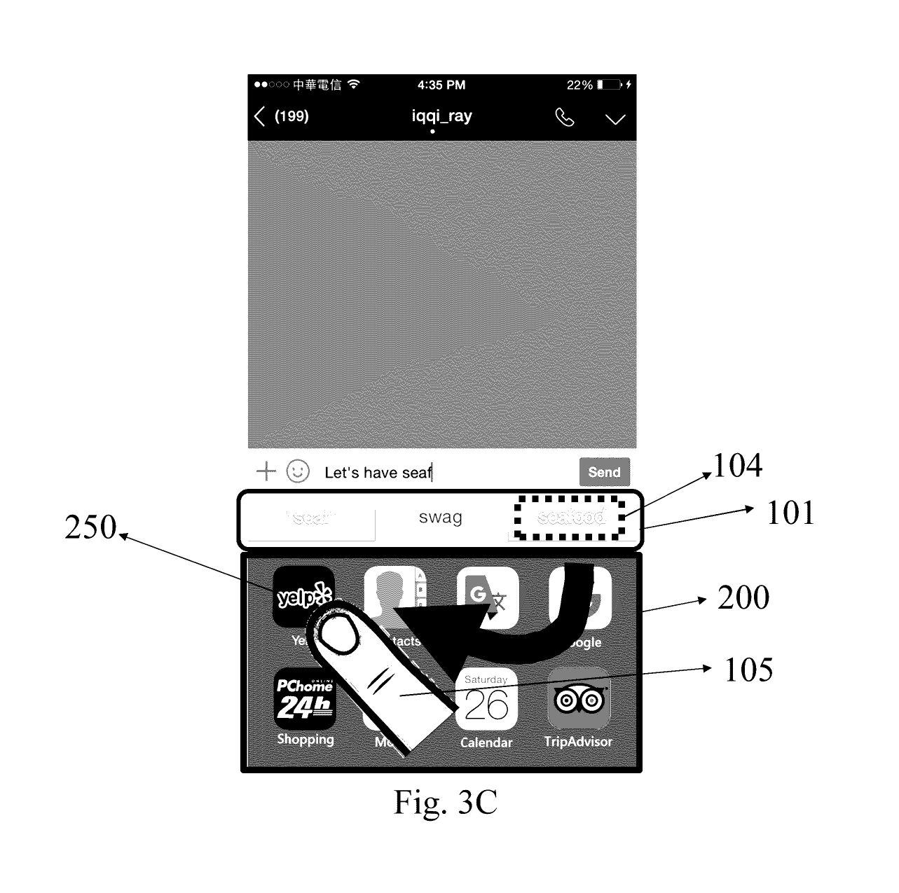

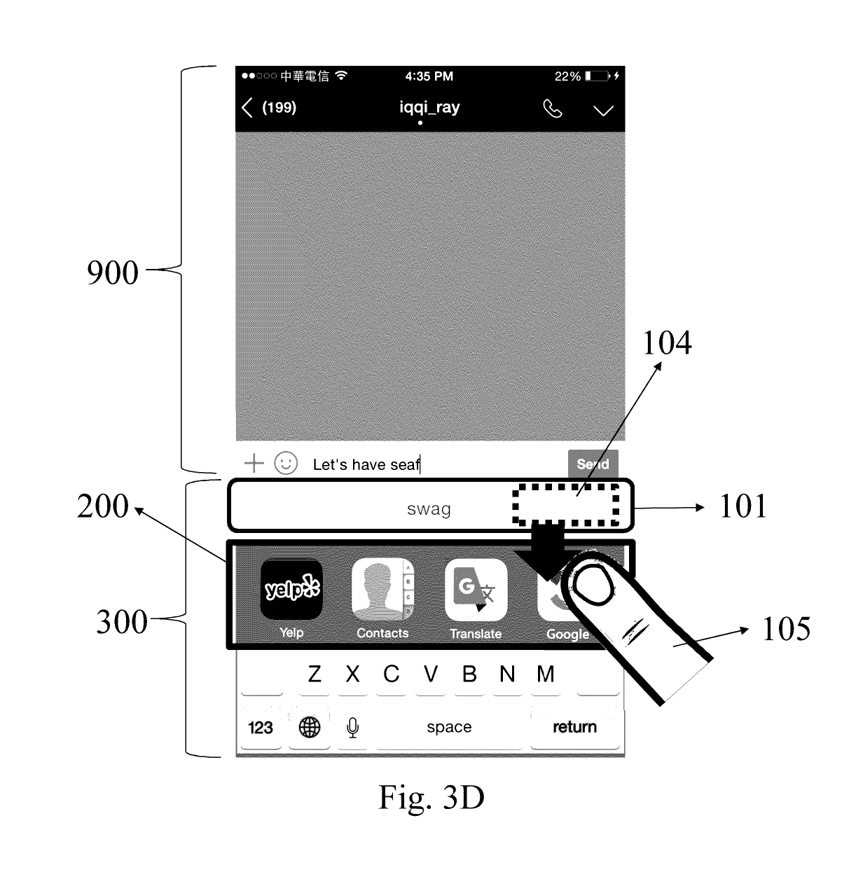

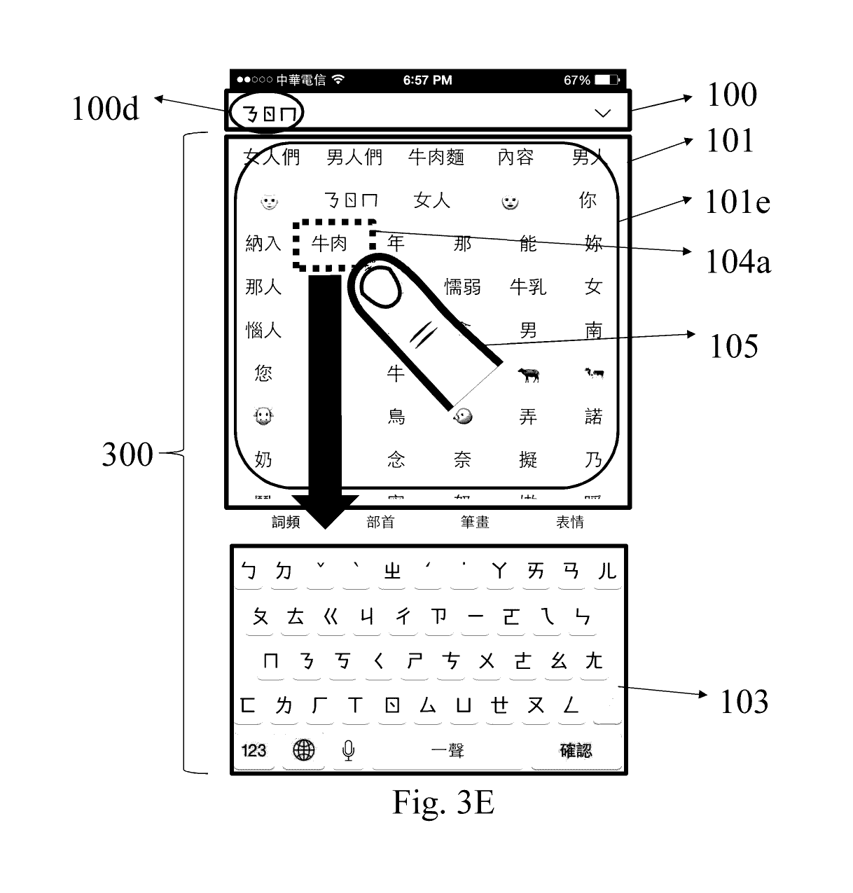

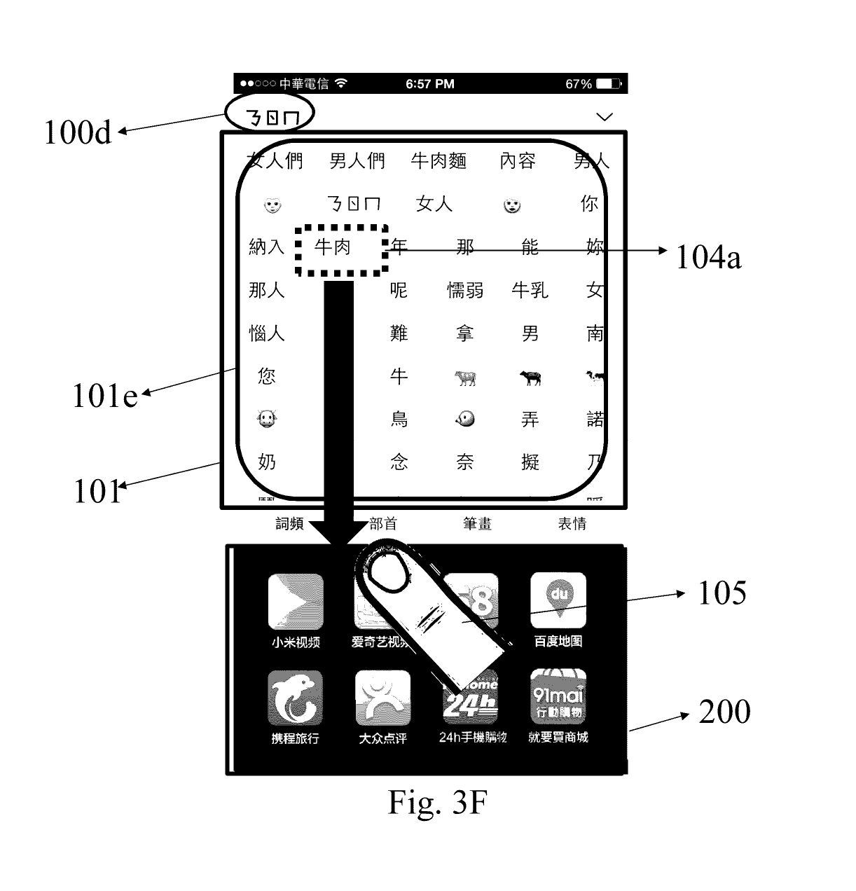

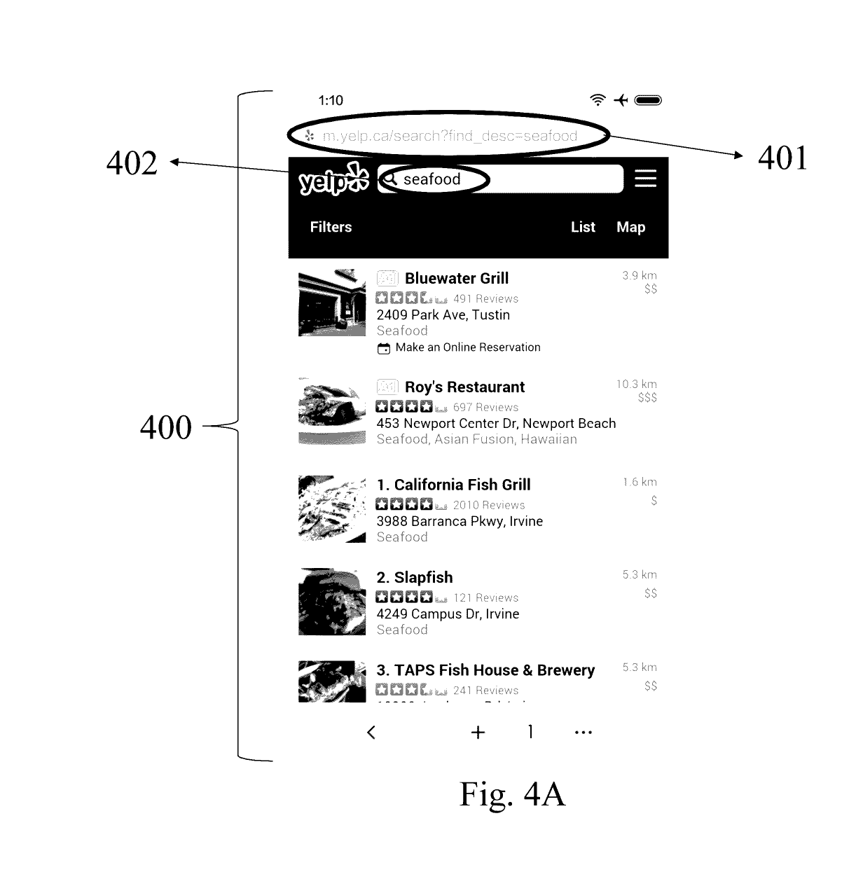

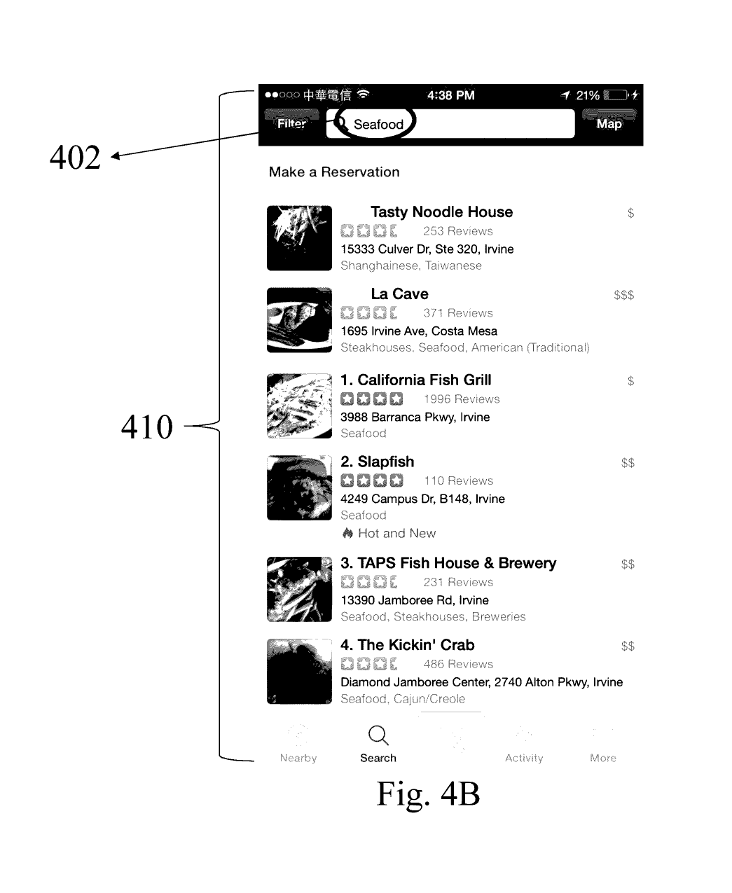

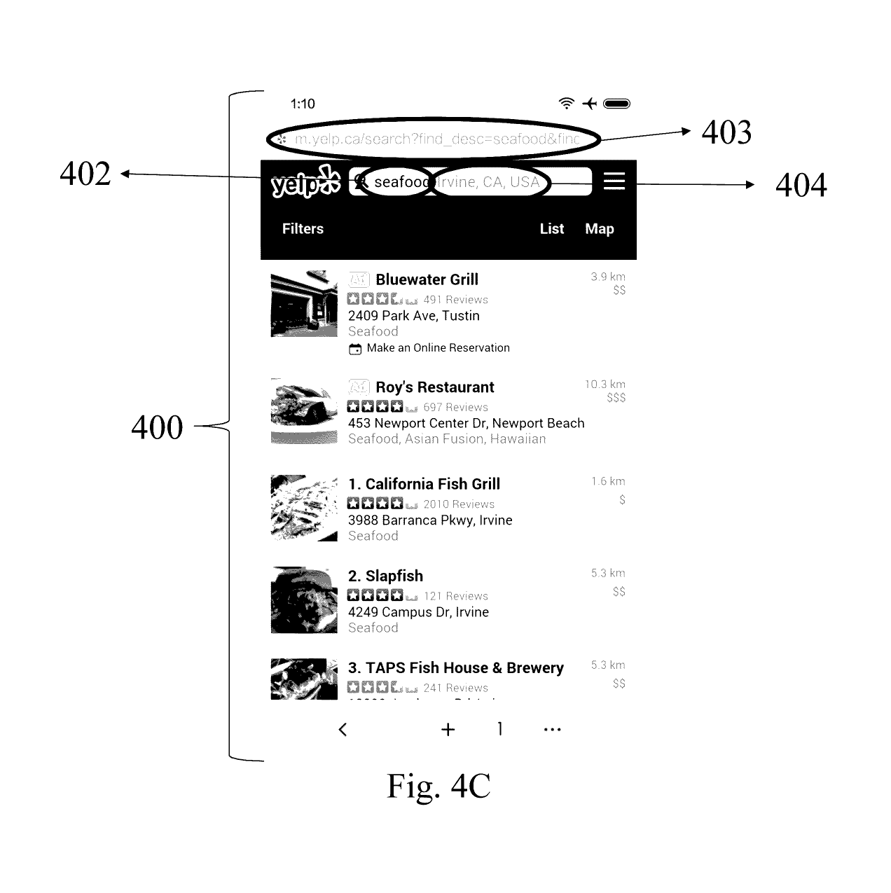

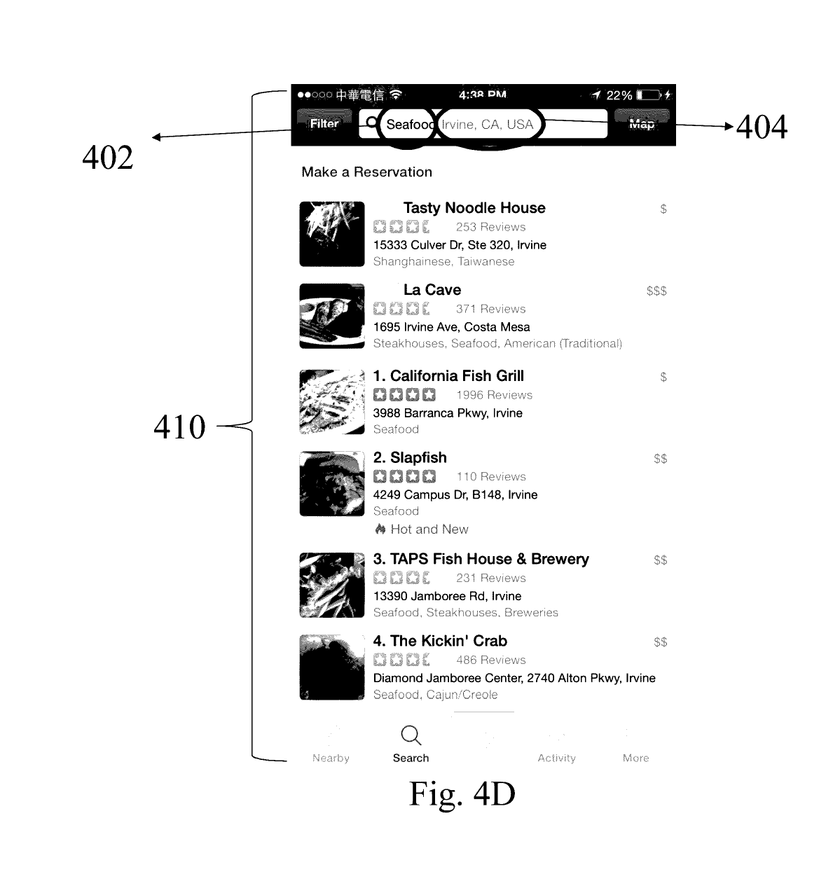

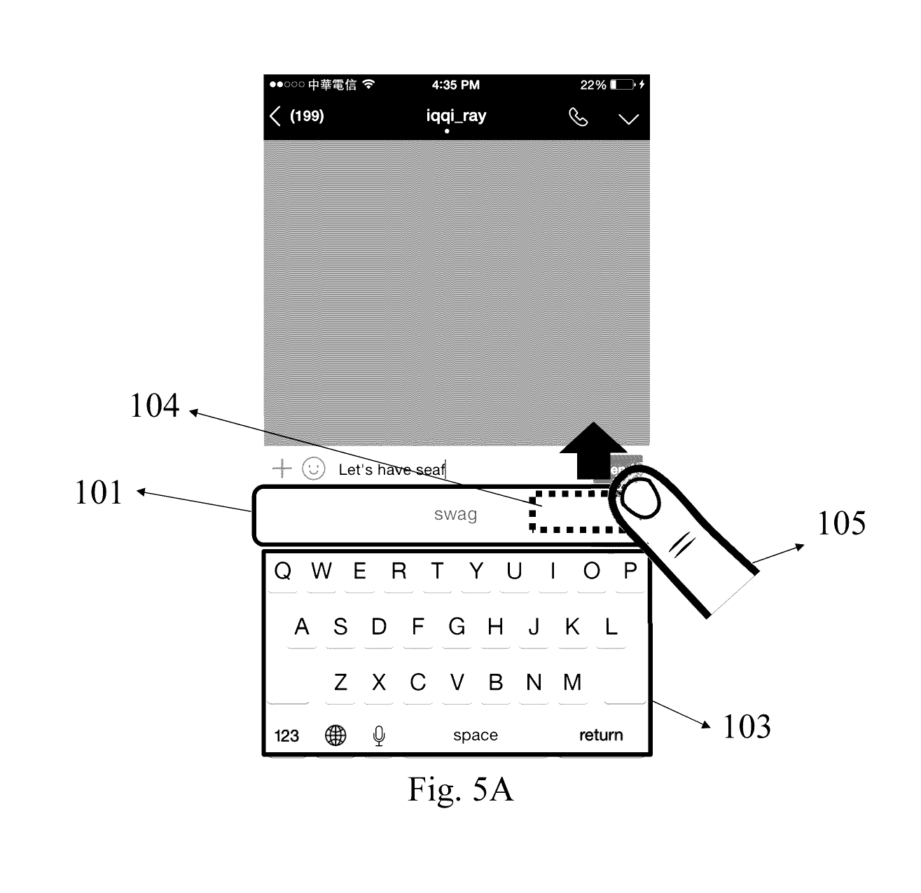

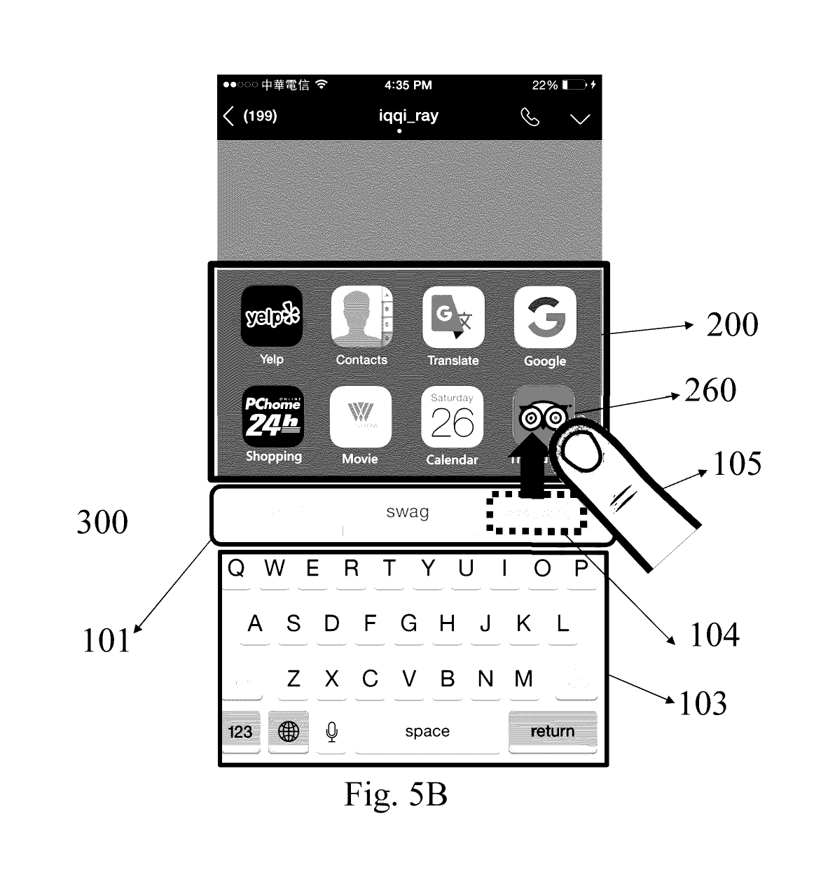

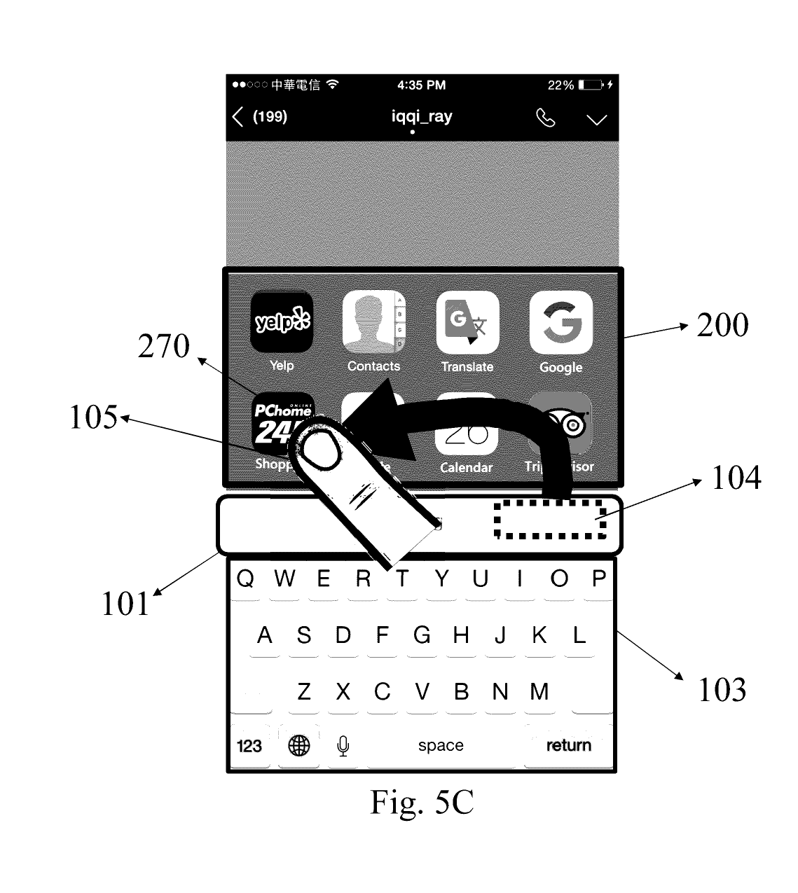

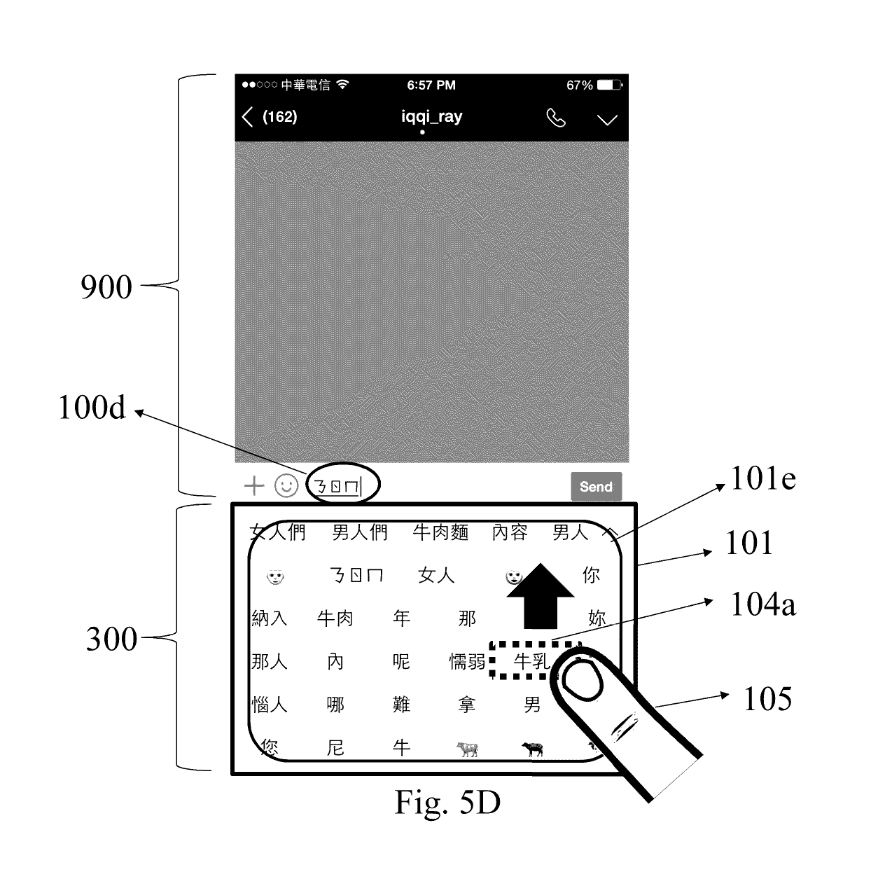

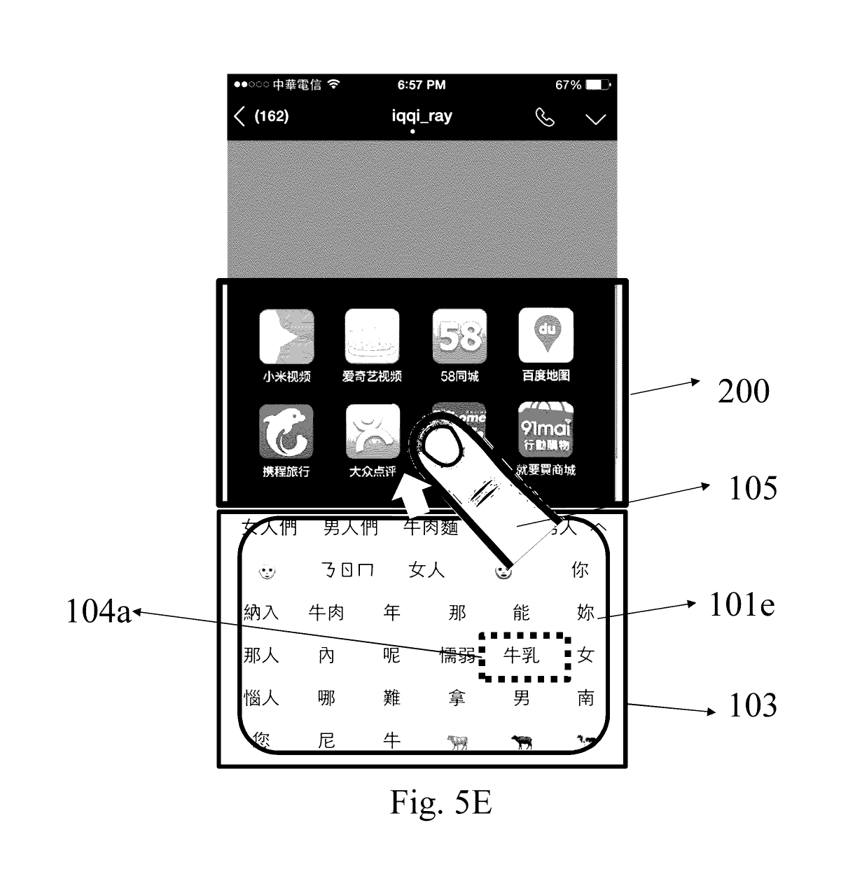

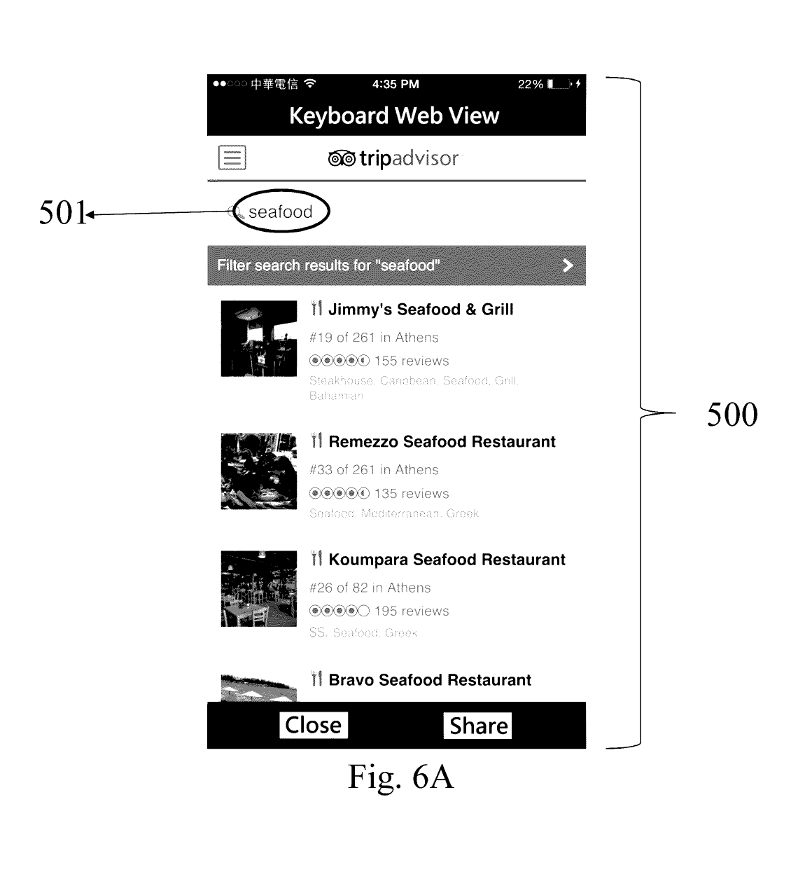

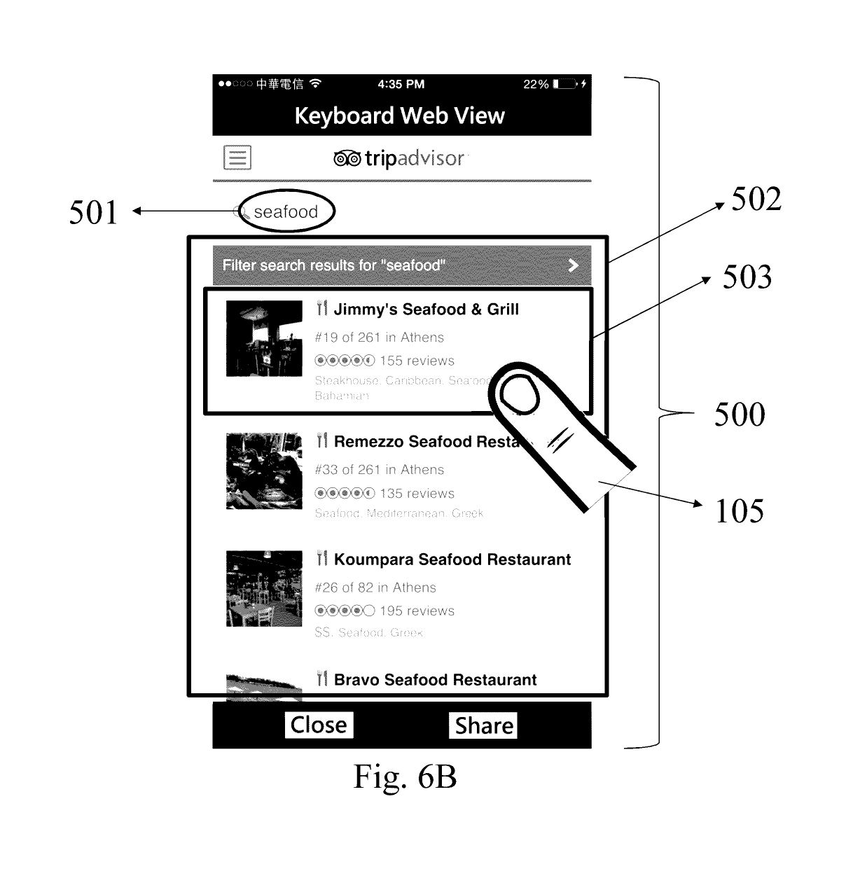

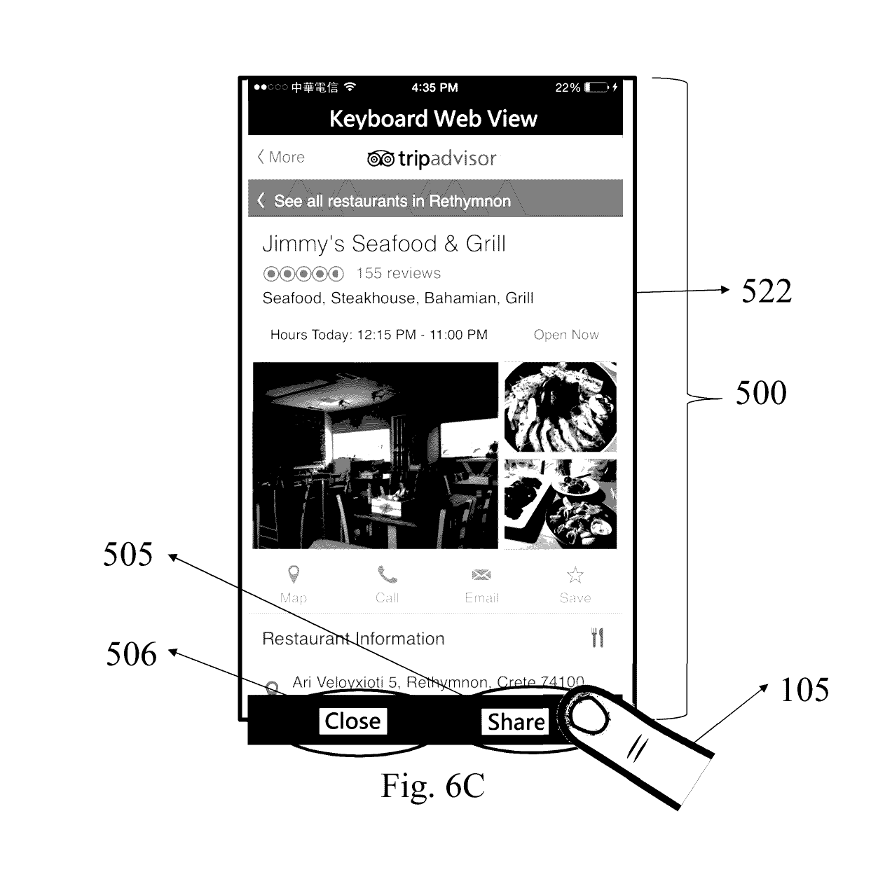

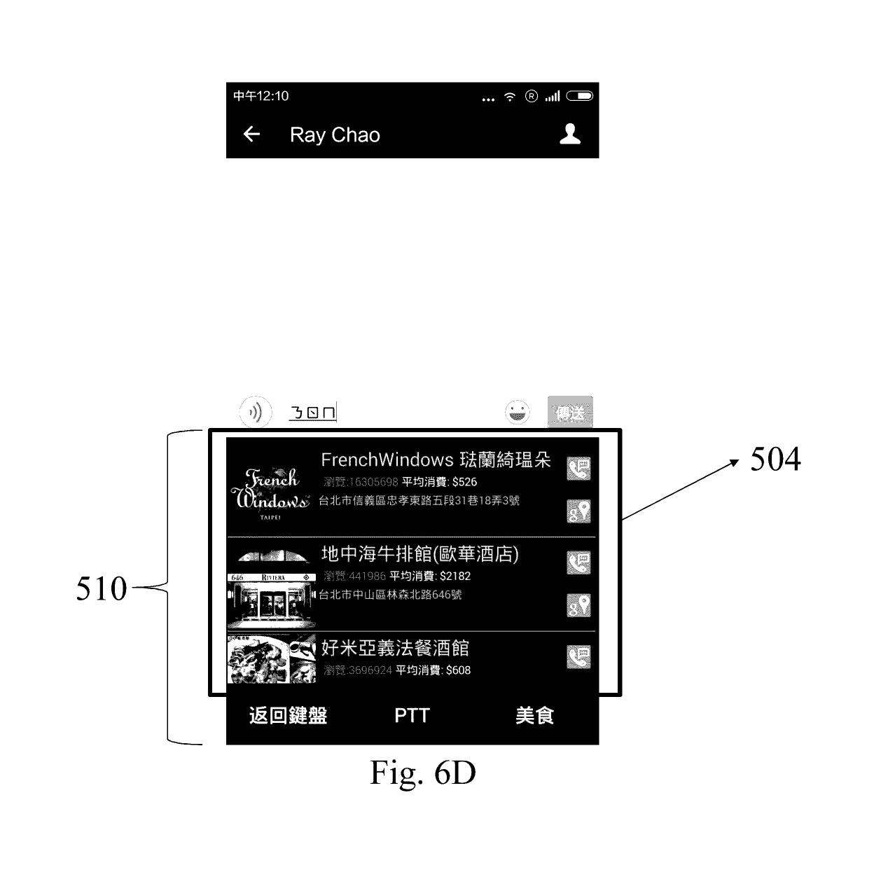

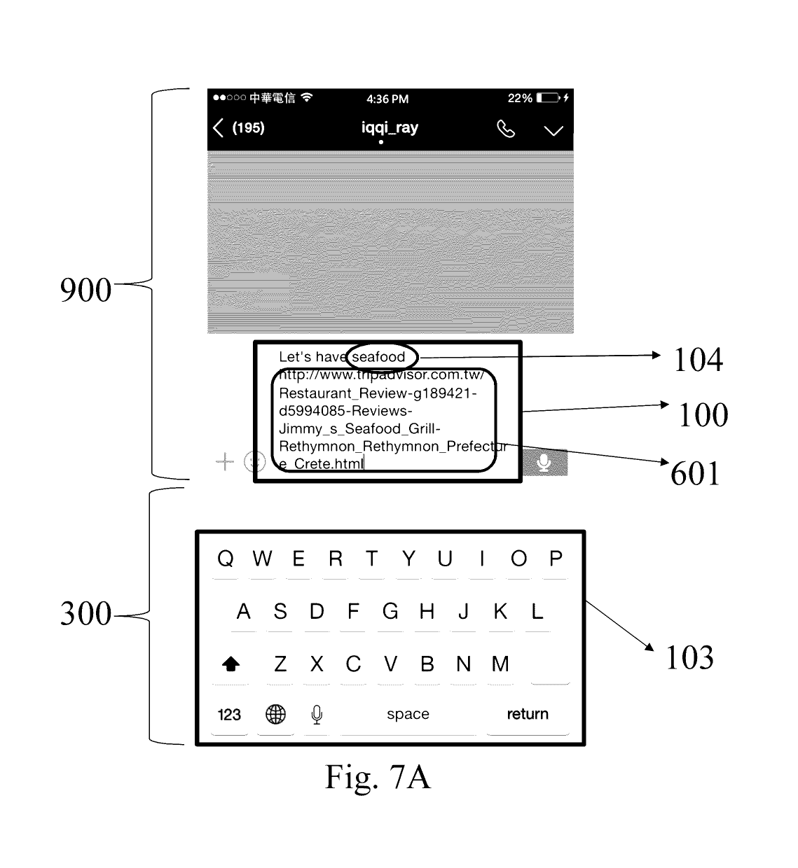

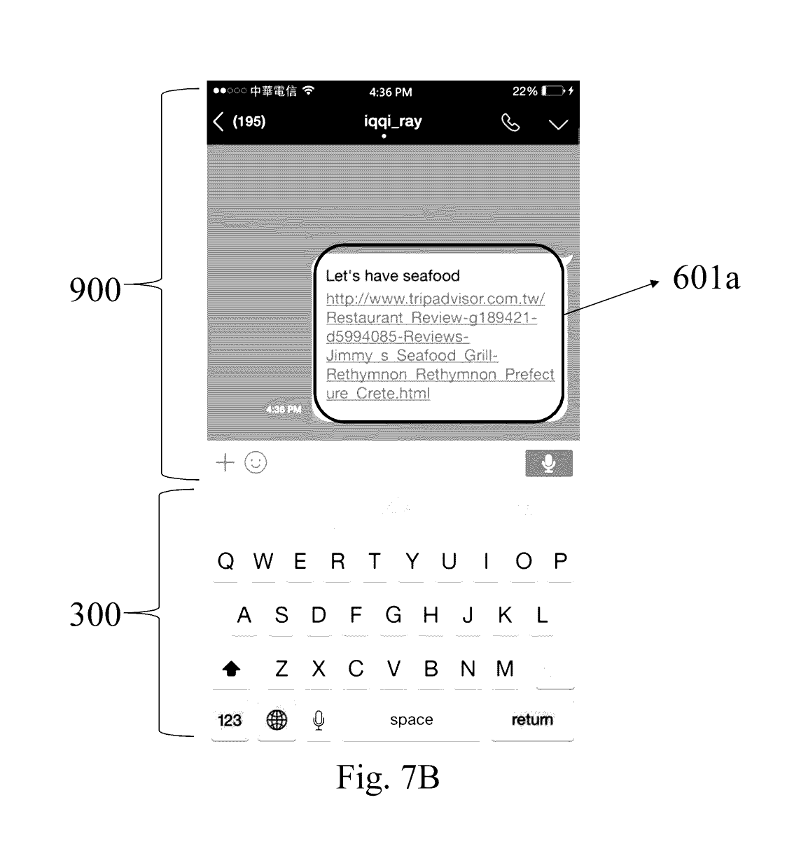

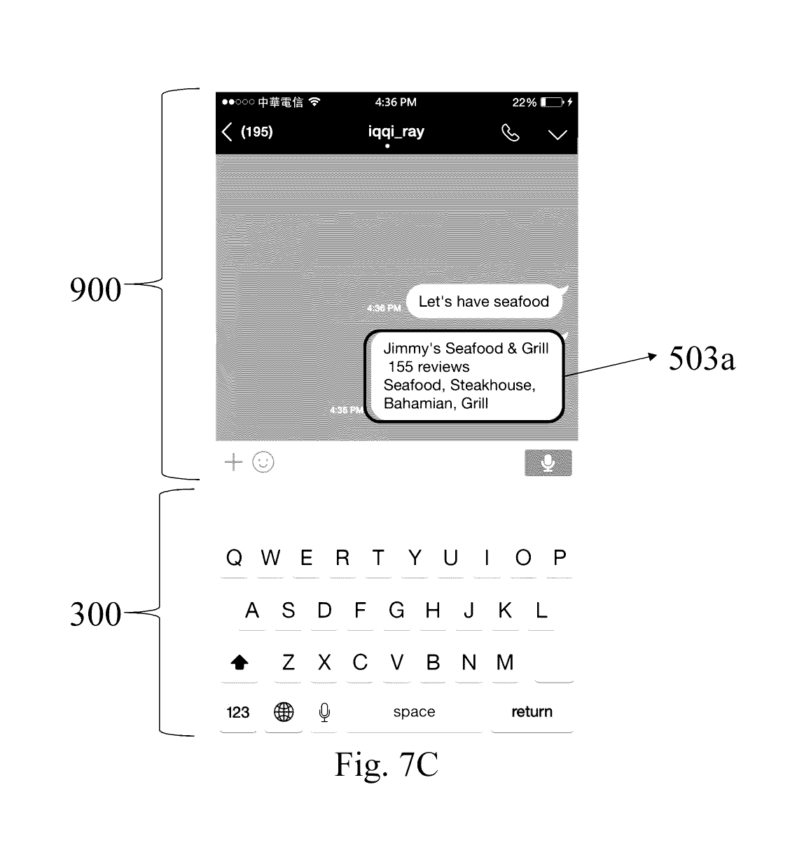

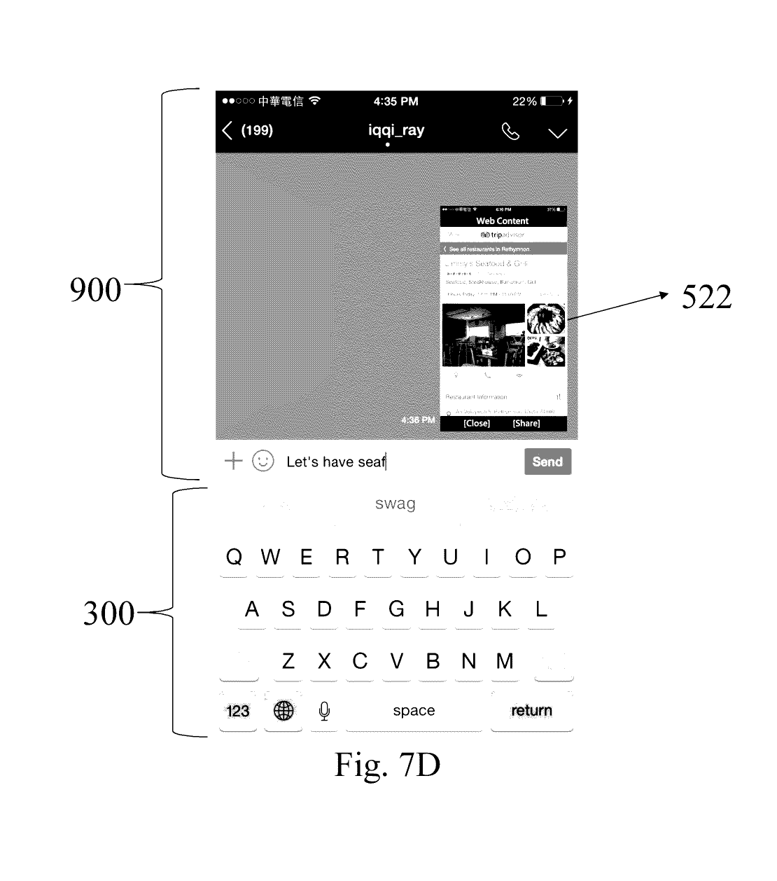

As shown in FIG. 6C, the above-mentioned new content can be the URL of a web page in the internal program 500, and the user can issue a command such as tap “Share” button 505 on the internal program to send the URL “http ://www.trip advisor.com.tw/Restaurant Review-g189421-d5994085-Reviews-Jimmy_s_Seafood_Grill-Rethymnon_Rethymnon_Prefecture_Crete.html” 601 of the web page or both the selected content “Seafood” 104 and the URL 601, to the input field 100 of the first application through virtual keyboard program 300, as shown in FIG. 7A. All contents in the input field can be further transferred to a dialogue box 601a in the first application 900, as shown in FIG. 7B.

As shown in FIG. 6B, the new content can also be a content “Jimmy's Seafood & Grill 155 reviews Seafood, Steakhouse, Bahamian, Grill” 503 from a list of contents 502, and the user can issue a command such as tap the content 503 from a list of contents 502 to send the content 503 to the input field 100 of the first application through virtual keyboard program 300 then transfer to the dialogue box 503a in the first application 900, as shown in FIG. 7C.

As shown in FIG. 6C, the new content can also be a grabbed picture 522 of the internal program 500, wherein the user can issue a command such as tap the “Share” button 505 on the internal program to send the grabbed picture 522 to the first application 900 through the virtual keyboard program 300, as shown in FIG. 7D.

The user can also tap the “Close” button 506 on the internal program to close the internal program, as shown in FIG. 6C.

If the second application is an external web browser or external application program, the new content can be sent to first application through virtual keyboard by operating system provided communication methods. The communication methods may be vary according to operating system and the supports of the external web browser or external application.

As shown in FIG. 5C, the finger 105 can continue the sliding and move from “TripAdvisor” 260 service to “PChome” 270 service to select the “PChome” 270 service in the service list area 200, wherein when the finger 105 is lifted from the touch screen at the “PChome” 270 service, the corresponding code with “PChome” service will be composed and executed to start a second application for obtaining new contents for inputting content.

FIGS. 3E-3F, 5D-5E, illustrate further two examples of a finger 105 on a predicted content 104a in the prediction list area 101e to select the content and a continuous sliding of the finger in a direction away from the prediction list area on the touch screen; and at least one identification of services is displayed in a service list area 200 on the touch screen.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the Claims appended hereto and their equivalents.

What is claimed is:

1. A method to provide a service while inputting content in an application through a virtual keyboard program, the method comprising:
running a virtual keyboard program launched by a first application with an input field for inputting content on a touch screen of an electronic device;
displaying at least one predicted content in a prediction list area in response to an inputting action on a virtual keyboard that is displayed on the touch screen by said virtual keyboard program;
detecting a pressing of a finger on a predicted content in said prediction list area to select said content and a continuous sliding of the finger in a direction away from the prediction list area on the touch screen;
displaying at least one identification of services in a service list area on the touch screen;
continuous sliding the finger onto an identification in the service list area on the touch screen and lifting the finger from said identification to select the service represented by said identification; and
composing and executing code according to the selected service to run a second application for obtaining new contents for inputting content to the first application, said code comprising a first portion for identifying the second application and a second portion comprising information associated with said selected content for identifying said new contents.

2. The method according to claim 1, wherein composing and executing code further comprising obtaining a new content from the second application and sending said new content to the first application though said virtual keyboard program.

3. The method according to claim 1, wherein composing and executing code further comprising: obtaining a new content from the second application; and sending said selected content and the new content to the first application though said virtual keyboard program by a command.

4. The method according to claim 1, wherein said predicted content in the prediction list area comprises at least one of the following: a word, a phrase, a text string, a symbol, an emoticon and a picture.

5. The method according to claim 1, wherein said continuous sliding of the finger in a direction away from the prediction list area is sliding down to the area below the prediction list area.

6. The method according to claim 1, wherein said service list area fully occupies the original virtual keyboard area.

7. The method according to claim 1, wherein said service list area overlays on a portion of the original virtual keyboard area.

8. The method according to claim 1, wherein said service list area is located above the prediction list area.

9. The method according to claim 1, wherein the at least one identification of services in said service list area is chosen according to the selected content.

10. The method according to claim 1, wherein the at least one identification of services in said service list area is further chosen according to the location of the electronic device.

11. The method according to claim 1, wherein the at least one identification of services in said service list area is further chosen according to the type of the first application.

12. The method according to claim 1, wherein the at least one identification of services in said service list area is further chosen according to information corresponding to the selected content in a database or type of the selected content.

13. The method according to claim 1, wherein the at least one identification of services in said service list area is further chosen according to at least one of the followings: type of the electronic device, the language being used on the virtual keyboard, gender of the user, age of the user, preference of the user, and present time.

14. The method according to claim 1, wherein said second application is an external web browser or an external application program linked to the virtual keyboard program through the operating system of the electronic device.

15. The method according to claim 1, wherein said second application is an internal program embedded inside the virtual keyboard program to browse web pages or a list of contents.

16. The method according to claim 1, wherein said new content is obtained from a list of contents displayed by said second application.

17. The method according to claim 1, wherein said new content is an URL of a web page obtained from said second application.

18. The method according to claim 1, wherein said a new content is a screenshot picture obtained from said second application.

19. The method according to claim 1, wherein said information associated with said selected content includes at least one of the followings: the selected content itself, the related word of the selected content, and information corresponding to the selected content in a database for identifying said new contents.

20. The method according to claim 1, wherein said second portion further comprises information associated with the location of the electronic device for identifying said new contents.
